(19) United States
(12) Patent Application Publication
(10) Pub. No.: US 2026/0179132 A1
(43) Pub. Date: Jun. 25, 2026

(54) SEAMLESS EXPLORATION AT THE POINT OF PERSONALIZATION

(71) Applicant: eBay Inc., San Jose, CA (US)

(72) Inventors: Dmitry BASIN, Haifa (IL); Haggai ROITMAN, Yokneam Ilit (IL)

(21) Appl. No.: 18/989,463

(22) Filed: Dec. 20, 2024

(51) Int. Cl. G06Q 30/0601

(52) U.S. Cl. CPC G06Q 30/0625; G06Q 30/0631; G06Q 30/0643

(57) ABSTRACT

Alternative options are presented to users at the point of personalization of a search engine to generate personalized query suggestions. Seed items within a module carousel comprising item cards on a homepage are identified. Embeddings are retrieved for at least a portion of the seed items. Based on the embeddings, related item embeddings corresponding to related items that were purchased by other users are identified. A list of queries for each of the related items that were purchased by the other users is retrieved. A ranking for each query of the list of queries is generated. Based on the ranking, queries of the list of queries are presented in place of at least one of the item cards within the module carousel. In various aspects, the queries of the list of queries broaden the intent, narrow the intent, or diversify the intent.

### BACKGROUND

Search engines are crucial in retrieving relevant items based on user-specified queries. Some search engines provide customized homepages for users. Failing to understand user intent makes it difficult for users to find relevant results, causing frustration and user churn. For example, without relevant items displayed on a user homepage, the user is forced to spend significant time and effort navigating pages of results or executing additional searches. Often, the user simply abandons the homepage rather than navigate a poorly personalized homepage.

### SUMMARY

Various aspects of the technology described herein are generally directed to systems, methods, and computer storage media for, among other things, generating personalized query suggestions. More particularly, aspects of the technology described herein provide alternative options to users at the point of personalization, enabling users to have additional opportunities to broaden, narrow, or diversify search intents. To do so, seed items within a module carousel comprising item cards on a homepage of a user are identified. Embeddings are retrieved for at least a portion of the seed items. Based on the embeddings, related item embeddings corresponding to related items that were purchased by other users are identified. A list of queries for each of the related items that were purchased by the other users is retrieved. A ranking for each query of the list of queries is generated. Based on the ranking, queries of the list of queries are presented in place of at least one of the item cards within the module carousel. In various aspects, the queries of the list of queries broaden the intent of the user, narrow the intent of the user, or diversify the intent of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 provides a block diagram of an exemplary store management system computing environment suitable for use in implementing aspects of the technology described herein;

FIG. 2 provides an example service for providing personalized query suggestions, in accordance with aspects of the technology described herein;

FIG. 3 provides an example voting algorithm, in accordance with aspects of the technology described herein;

FIG. 4 provides an example cluster labeling algorithm, in accordance with aspects of the technology described herein;

FIGS. 5a-5c provide example user interfaces illustrating various personalized query suggestions, in accordance with aspects of the technology described herein;

FIG. 6 is a flow diagram showing an example method, in accordance with an aspect of the technology described herein, in accordance with aspects of the technology described herein; and

FIG. 7 is a block diagram of an exemplary computing environment suitable for use in implementing aspects of the technology described herein.

### DETAILED DESCRIPTION OF THE INVENTION

A store management system supports storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California.

Conventionally, search systems are not configured to effectively provide alternative options to broaden, narrow, or diversify user intent at the point-of-personalization (e.g., items displayed to user in a homepage module). Instead, search systems rely on a user to navigate pages of results or execute additional searches to identify queries and items relevant to the actual intent of the user. Without relevant items displayed on the homepage, the user is forced to spend significant time and effort searching or browsing categories.

This requires the user to perform multiple searches to find a particular item and unnecessarily consumes various computing resources of the store management system, such as processing power, network bandwidth, throughput, memory consumption, etc. In some instances, the multiple attempts to find a particular item may even completely fail to satisfy the user's goal, thus requiring the user to spend even more time and computing resources on the search process by repeating the process of issuing additional queries until the user finally accesses the desired content items. In some cases, the user may even give up searching because the search engine was not able to return desired search results after multiple searches.

These shortcomings of existing search systems adversely affect computer network communications. For example, each time a query is received, contents or payload of the search queries is typically supplemented with header information or other metadata, which is multiplied by all the additional queries needed to obtain the particular item. As such, there are throughput and latency costs by repetitively generating this metadata and sending it over a computer network. In some instances, these repetitive queries increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if multiple users repetitively issue queries, it is expensive because processing queries consumes a lot of computing resources. For example, for some search engines, a query execution plan may need to be calculated each time a query is issued, which requires a search system to find the least expensive query execution plan to fully execute the query. This decreases throughput and increases network latency, and can waste valuable time.

Aspects of the technology described herein improve the functioning of the computer itself in light of these shortcomings in existing search systems by providing a solution that generates personalized query suggestions. The personalized query suggestions provide alternative options to users at the point of personalization, enabling users to have additional opportunities to broaden, narrow, or diversify search intents. As can be appreciated, better results are achieved compared to traditional search systems that require extensive browsing and filtering of search results or executing multiple search queries.

Aspects of the technology described herein provide a number of improvements over existing search systems. For instance, computing resource consumption is improved relative to existing technologies. In particular, the homepage of the user is enhanced by automatically providing personalized query suggestions, thereby allowing the user to more quickly access relevant search results. This eliminates (or at least reduces) the extensive browsing and filtering of search results or executing multiple search queries because the personalized query suggestions enable the user to broaden, narrow, or diversify search intents. Accordingly, aspects of the technology described herein decrease computing resource consumption, such as processing power and network bandwidth. For instance, a user query (e.g., an HTTP request), would only need to traverse a computer network once (or fewer times relative to existing technologies).

In like manner, aspects of the technology described herein improve storage device or disk I/O and query execution functionality. As described above, the inability to broaden, narrow, or diversify search intents at the point of personalization results in repetitive user queries and filter selections. This causes multiple traversals to disk I/O. In contrast, aspects described herein reduce storage device I/O because the user provides a reduced amount of inputs so the computing system does not have to reach out to the storage device as often to perform a read or write operation. For example, by automatically providing personalized query suggestions the user is able to more quickly access relevant search results. Accordingly, there is not as much wear due to query execution functionality.

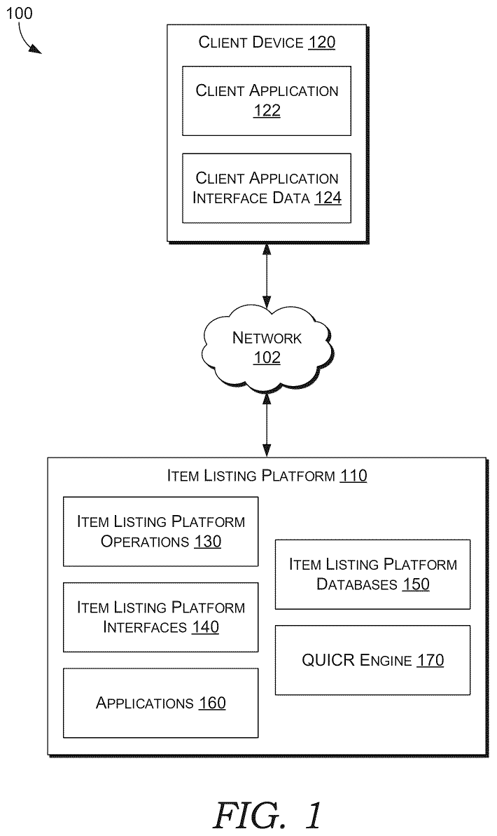

Referring now to FIG. 1, FIG. 1 illustrates an example store management system 100 in which implementations of the present disclosure may be employed. In particular, FIG. 1 shows a high level architecture of an example store management system 100 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The store management system 100 can be a cloud computing environment that provides computing resources for functionality associated with the store management system 100. For example, the store management system 100 supports delivery of computing components and services-including servers, storage, databases, networking, and applications associated with the item listing platform 110 and client device 120. A plurality of client devices (e.g., client device 120) include hardware or software that access resources on the store management system 100. Client device 120 can include an application (e.g., client application 122) and interface data (e.g., client application interface data 124) that support client-side functionality associated with the store management system. The plurality of client devices can access computing components of the store management system 100 via a network (e.g., network 102) to perform computing operations.

The item listing platform 110 is responsible for providing a computing environment or architecture that includes the infrastructure that supports providing e-commerce functionality. The item listing platform 110 supports storing item in item databases and providing a search system for receiving queries and identifying search results based on the queries. The item listing platform 110 may also provide a computing environment with features for managing, selling, buying, and recommending different types of items. Item listing platform 110 can specifically be for a content platform such as EBAY content platform or e-commerce platform, developed by EBAY INC., of San Jose, California.

The item listing platform 110 can provide item listing operations 130 and item listing interfaces 140. The item listing operations 130 can include service operations, communication operations, resource management operations, security operations, and fault tolerance operations that support specific tasks or functions in the item listing platform 110. The item listing interfaces 140 can include service interfaces, communication interfaces, resource interfaces, security interfaces, and management and monitoring interfaces that support functionality between the store management platform components. The item listing operations 130 and item listing interfaces 140 can enable communication, coordination and seamless functioning of the store management system 100.

By way of example, functionality associated with item listing platform 110 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 110 may comprise item listing platform databases (e.g., item listing platform databases 150) to manage and store different types of data efficiently. The item listing platform databases 150 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 110 supports applications (e.g., applications 160) that may be a computer program, software component, or service that serves a specific function or set of functions to fulfil a particular item listing platform requirement or user requirement. Applications can be client-side (user-facing) and server-side (backend). By way of example, applications can include an online storefront application, mobile shopping app, admin and management console, payment gateway integration, user account and authentication application, search and personalization engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The item listing platform 110 can include a queries on item card (QUICR) engine 170. In aspects, the QUICR engine 170 generates personalized query suggestions. For example, the QUICR engine 170 provides alternative options to users at the point of personalization, enabling users to have additional opportunities to broaden, narrow, or diversify search intents. To do so, the QUICR engine 170 analyzes data and issues a number of API calls, such as to item listing platform databases 150.

Initially, the QUICR engine 170 treats any set of items at any point-of-personalization (e.g., items displayed to user in a homepage module) as a seed-item for additional exploration. Next, the QUICR engine 170 maps the seed-items set into potential exploration options for the user based on the purchase propensities of relevant candidate entities (e.g., queries, aspects, categories, sellers, etc.). Based on the content of seed-items, the QUICR engine 170 determines which strategy of exploration is best suited for the user.

In one example, the QUICR 170 determines a strategy of broadening the user's intent (e.g., suggest related queries that expand specific items to a set of similar items). In another example, the QUICR 170 determines a strategy of narrowing the user's intent (e.g., suggest related queries that expand current items with specific aspects). In yet another example, the QUICR 170 determines a strategy of diversifying the user's intent (e.g., suggesting queries that go beyond a single category). In some aspects, the QUICR engine 170 provides the suggested queries in the homepage module (e.g., in place of an item card within a module carousel).

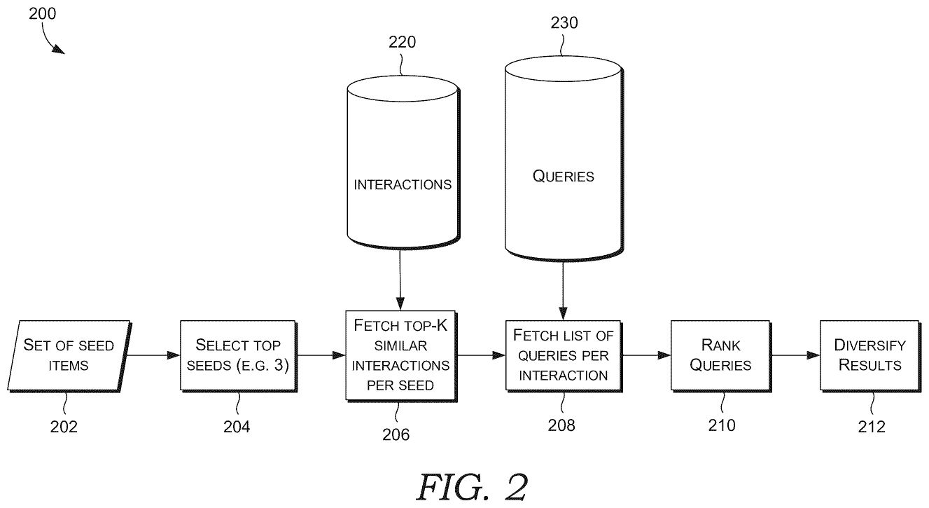

With reference to FIGS. 2-6, examples of various aspects of generating personalized query suggestions are provided. The aspects described may be performed using the store management system described herein. In embodiments, one or more computer-storage media having computer-executable or computer-useable instructions embodied thereon that, when executed, by one or more processors can cause the one or more processors to perform the aspects (e.g., computer implemented method) in a store management system (e.g., computerized system or computer system).

Referring now to FIG. 2, an example service 200 for providing personalized query suggestions is illustrated, in accordance with aspects of the technology described herein. The service 200 is capable of generating recommended queries satisfying the requirements based on a given set of seed items representing the intent (or interests) of the user. Initially, given a set of seed items 202, the service 200 employs a seed embedding algorithm to derive a set of seed embeddings (e.g., three embeddings) 204. In some aspects, the set of seed items 202 are represented by item cards within a particular module (carousel) of the user homepage. For example, the set of seed items may be the item cards currently displayed in the recently viewed items (RVIs) module of the user homepage. In another example, the set of seed items may be the item cards currently displayed in the watchlist module of the user homepage. It is contemplated and within the scope of this disclosure that item cards in any module of the user homepage may be utilized as a set of seed items.

The seed embedding algorithm may prioritize the most relevant seed items and utilize their embeddings. In aspects, the primary aim of seed selection is to accurately discern the current intent of the user. The algorithm employed for selection depends on the specific use case (e.g., focused recommendations, diverse item coverage, etc.). For example, for modules featuring a narrow list of items, the personalized query suggestions prioritize common themes related to those items. In another example, for modules containing diverse items, the personalized query suggestions encompass a wide range of topics, maximizing coverage.

As can be appreciated, the goal of query recommendation is to generate personalized query suggestions tailored to each module carousel on the homepage. In this way, the personalized query suggestions may directly relate to the content of the module and reflect the user's current interests, spanning a range of topics inferred from the initial items within the module. In some aspects, the personalized query suggestions may be provided on a single card within the carousel, integrated alongside other recommended items. Placement of the personalized query suggestions at the end of the carousel ensures no additional space allocation is required within the homepage. As a result, optimal performance can be maintained. Additionally, the service 200 accommodates both single category modules and cross-category modules.

Generally, the seed embedding algorithm generates multiple seed embeddings, each representing a variation of user interests. In some aspects, each item card within the module carousel allows for up to three queries. Accordingly, three distinct seed embeddings may be generated for the subsequent stage (i.e., a call to a similarity algorithm). Each seed embedding is used to call the similarity algorithm.

In one aspect, the seed embedding algorithm is a focused selection algorithm. For example, some homepage modules may predominantly display items from a single leaf category. These modules primarily rely on a set of RVIs by the user, typically within the same leaf category and temporally clustered.

For example, the focused selection algorithm may be a rule-based model. Initially, the rule-based model selects the latest and two most frequently occurring items from the associated RVIs of the module. In cases where the module's RVIs are limited, the set can be expanded by incorporating co-views relevant to the module's theme or query. Subsequently, embeddings of the selected items are retrieved and used as seeds for the similarity algorithm. The rule-based model simplifies calculations and reduces latency by avoiding additional endpoint calls. Further, leveraging item embeddings enhances item-to-item similarity, particularly beneficial for a la carte embeddings.

In another example, the focused selection algorithm may be a propensity model (e.g., Extreme Gradient Boosting). In this approach, RVIs are ranked and top-scoring items are selected. Embeddings of the selected items are obtained and utilized as seeds for the similarity algorithm. Because the propensity model eliminates the need for multi-hop calls, it realizes the advantages of the rule-based model while improving the selection of the most relevant items. In another example, the focused selection algorithm may be a neural network model. In this approach, given a set of RVIs related to the module, the neural network model generates seed embeddings.

In another aspect, the seed embedding algorithm is a diverse selection algorithm. For, example, in some modules (e.g., watchlist, RVIs, etc.), a diverse set of items from different categories and viewed by a user over a wide period may be represented. In this scenario, it may be preferable to select seed items from different categories while limiting the time to the last interactions to avoid showcasing outdated interests. To select representatives from the diverse set of items representing the module, a variant of the focused algorithm can be applied to each set from the same leaf category. Then, top-rated items from each category can be chosen in a round-robin manner.

In some aspects, the set of seed embeddings is used to call a similarity algorithm (e.g., a k-Nearest Neighbor (KNN) algorithm) to fetch, from an interactions database 220, similar interactions per seed (e.g., top-k similar interactions) 206. Consequently, a set of k multiplied by the number of seed embedding vectors may be obtained. In some aspects interactions comprise purchases and the interactions database 220 comprises purchases. In other aspects, the interactions database 220 may comprise a la carte embeddings corresponding to bid, buy-it-now, offer, watch, ask and add to cart (BBOWAC) items.

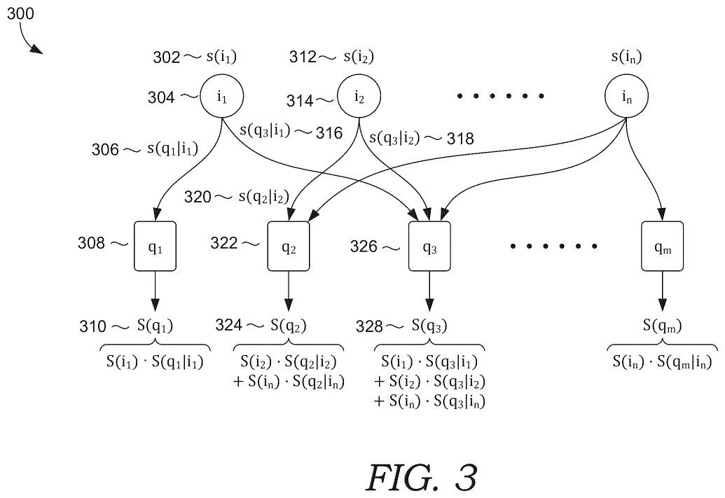

After the top-k similar interactions per seed have been retrieved, the service 200 issues a call to retrieve the list of queries for each of the retrieved similar items 208 from a queries database 230. A ranking algorithm 210 may be applied to generate a propensity score for each query in the retrieved lists. Referring now to FIG. 3, an example ranking algorithm (e.g., a voting algorithm) is provided, in accordance with aspects of the technology described herein.

S(i) 302, 312 can be defined as the score of item i 304, 314, and S(q|i) 306, 316, 318, 320 can be defined as the score for query q 308, 322, 326 in the context of item i 304, 314, which appears in the query results. The contribution of item i 304, 314 to the final score of query q 308, 322, 326 is represented as S(i) 302, 312 multiplied by S(q|i) 306, 316, 318, 320. Consequently, the final score for query q 308, 322, 326 within the context of a set of items {i1 304, i2 314, . . . , in} is the summation of contributions from each item:

$$S ( q ) = {\sum }_{k = 1}^{n} S ( q \vert {i}_{k} ) \cdot S ( {i}_{k} ) 310 , 324 , 328$$

The score S(i) assigned to item i captures its overall appeal and similarity to the original seed. In addition to considering factors such as clicks, watches, purchases, and the average position in search results, items that align closely with the original seed may also be prioritized. To maintain consistency and balance in scoring, contributions from clicks, watches, and purchases can be normalized to a range between 0 and 1. This normalization ensures that each metric's influence is proportional and prevents outliers from skewing the scoring process. Additionally, inverse function can be incorporated for the average position, favoring items appearing higher in search results. The extended formula for score S(i) is:

$$Sim ( i , seed ) \cdot ( {w}_{1} \cdot \frac{{Clicks}_{i}}{Max {Clicks}_{i}} + {w}_{2} \cdot \frac{{Watches}_{i}}{Max {Watches}_{i}} + {w}_{3} \cdot \frac{{Purchases}_{i}}{Max {Purchases}_{i}} + {w}_{4} \cdot \frac{Min {AveragePosition}_{i}}{{AveragePosition}_{i}} )$$

Here, “Min”/“Max” variables represent the minimum/maximum observed counts in the set of n items for clicks, watches, and purchases, respectively. The “AveragePosition” variable represents the average position of item i in the set of m queries. In some aspects, weights w1, w2, w3, and w4 can be adjusted to fine-tune the significance of each factor in determining the final score, ensuring items with higher relevance, engagement, better positioning, and/or similarity to the original seed are appropriately prioritized. In some aspects, user feedback can be leveraged to train machine learning models to generate S(i) scores.

A contextual query score S(q|i) may represent the propensity of a query given that the user is interested in item i appearing in the query results. The contextual query score may serve as a proxy for the likelihood of a query being relevant to item i. In one aspect, a straightforward approach can be employed using the equation:

$$\frac{1}{rank ( i \vert {q}_{r} )} ,$$

where rank (i|qᵣ) denotes the position of item i in the query qᵣ. Further, as shown in the contextual query score equation below, this value can be normalized among the set of all m candidate queries to ensure comparability across queries:

$$S ( {q}_{r} \vert i ) = \frac{1 / rank ( i \vert {q}_{r} )}{{\sum }_{j = 1}^{m} \frac{1}{rank ( i \vert {q}_{r} )}}$$

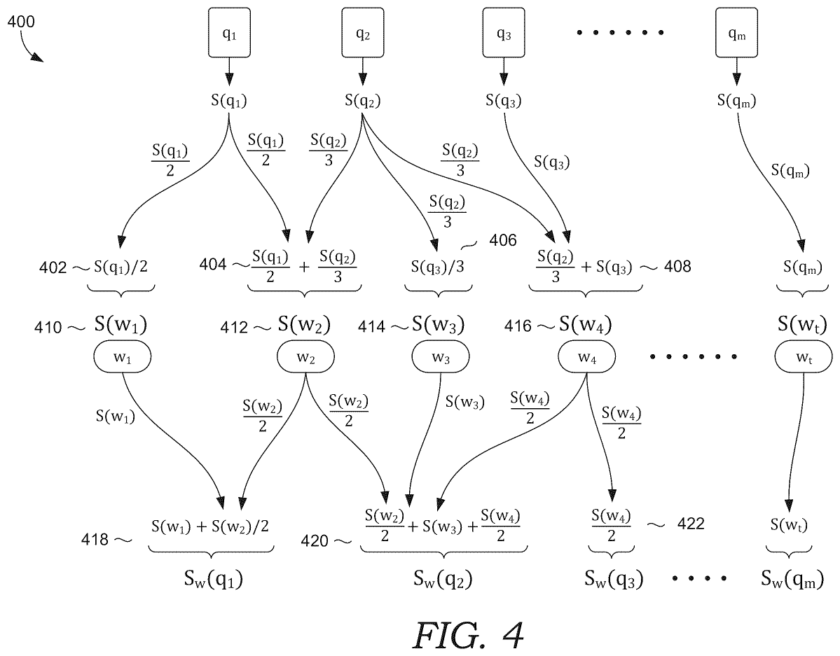

Turning now to FIG. 4, an example ranking algorithm (e.g., cluster labeling algorithm) is provided, in accordance with aspects of the technology described herein. The cluster labeling algorithm enhances the basic vote counting process by introducing an additional stage. The additional stage parses all the words within queries and evenly distributes the query's voting score among these words. The score for each word, denoted as S(w), is computed by a summation 402, 404, 406, 408 of score fractions from every query in which the word appears. Subsequently, the word score S(w) 410, 412, 414, 416 is evenly redistributed back across all queries containing the word 418, 420, 422. This redistribution of scores effectively diminishes the significance of words prevalent in a majority of queries, while amplifying the importance of words specific to queries with high scores.

Referring back to FIG. 2, a diversification algorithm 212 may be employed to eliminate overly similar queries and select the top-3 distinct queries with the highest rank scores. In some aspects, Jaccard similarity metrics may be leveraged to assess the textual content of queries and subsequently eliminate items with lower scores that exhibit significant similarity.

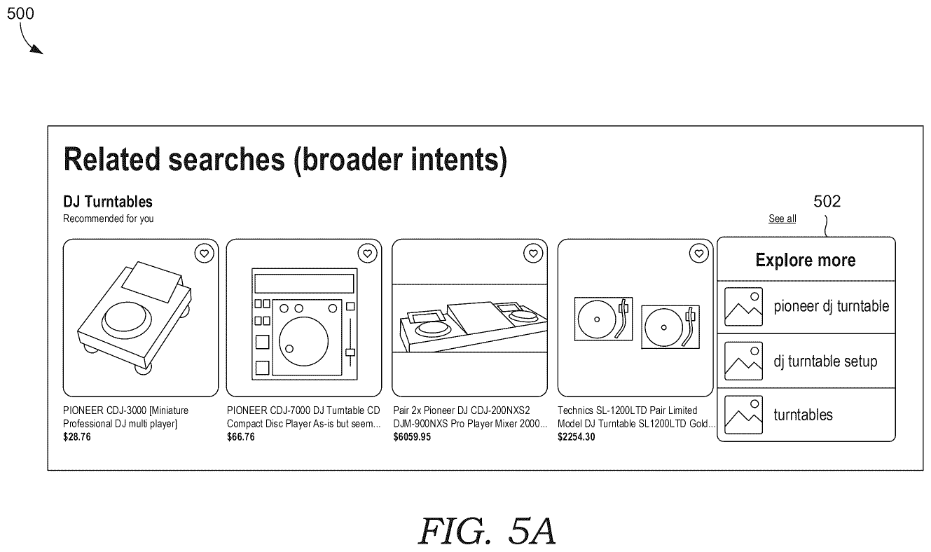

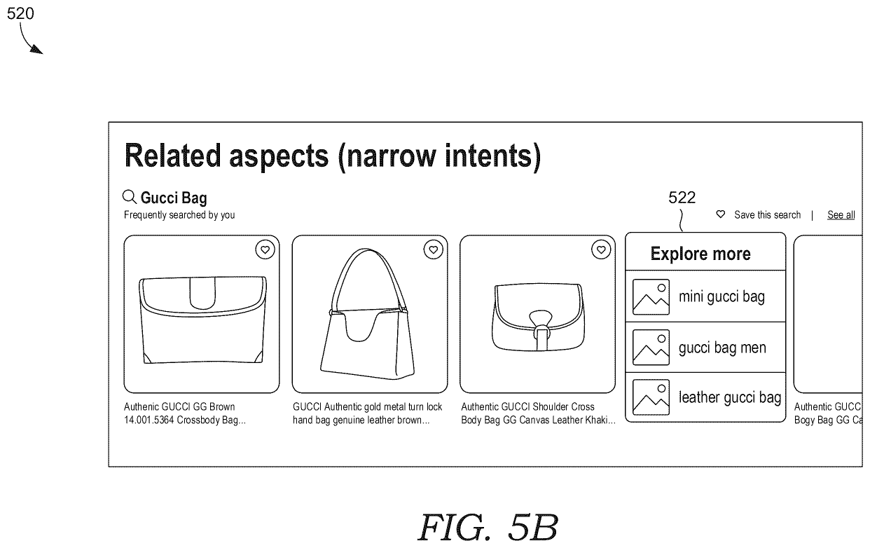

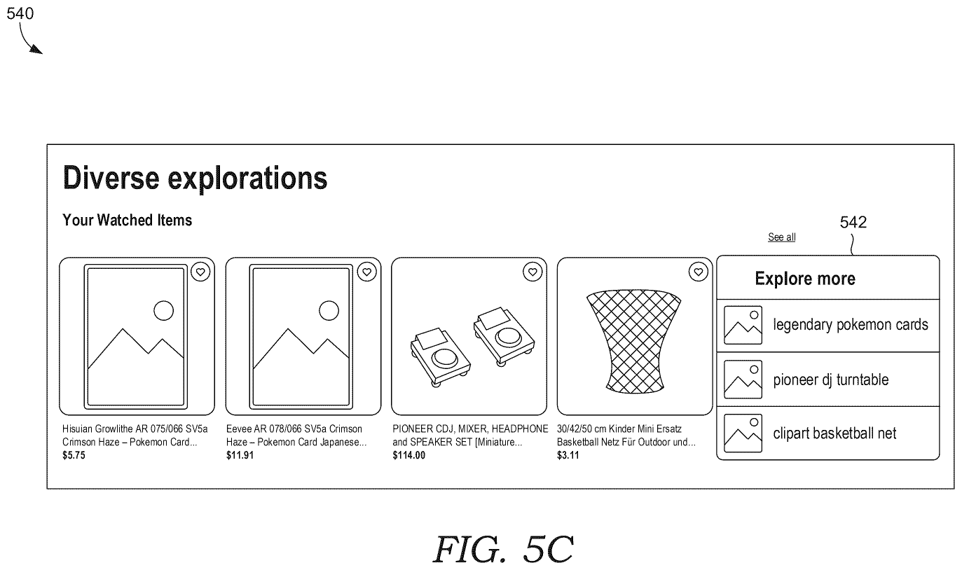

In practice, and turning now to FIGS. 5A-5C, example user interfaces 500, 520, 540 illustrate various query suggestions, in accordance with aspects of the technology described herein. For example, FIG. 5A is an example user interface 500 illustrating a homepage module recommending “DJ turntables” for the user. As illustrated, the module provides four item cards for “DJ turntables.” The fifth item card 502 in the module provides personalized query suggestions that broaden the intent of the user. For example, the personalized query suggestions are for “pioneer dj turntable,” “dj turntable setup,” and “turntables.” In some aspects, images are retrieved and selected from an image database to provide along with each personalized query suggestion in the fifth item card 502. The images may be retrieved and selected in the same manner as described with respect to query suggestions.

In another example, FIG. 5B is an example user interface 520 illustrating a homepage module providing item cards corresponding to frequent searches by the user. As illustrated, the module provides four item cards for “Gucci Bag.” The fifth item card 522 in the module provides personalized query suggestions that narrow the intent of the user. For example, the personalized query suggestions are for “mini gucci bag,” “gucci bag men,” and “leather gucci bag.” In some aspects, images are retrieved and selected from an image database to provide along with each personalized query suggestion in the fifth item card 522.

In yet another example, FIG. 5C is an example user interface 540 illustrating a homepage module providing item cards corresponding to watched items by the user. As illustrated, the module provides four item cards for items designated as watched items by the user. The fifth item card 542 in the module provides personalized query suggestions that diversify the intent of the user. For example, the personalized query suggestions are for “legendary pokemon cards,” “pioneer dj turntable,” and “clipart basketball net.” In some aspects, images are retrieved and selected from an image database to provide along with each personalized query suggestion in the fifth item card 542.

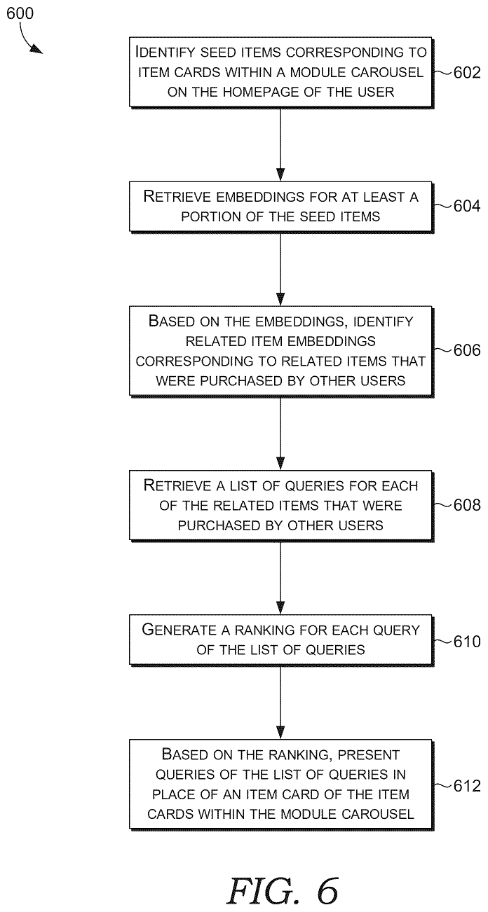

Referring now to FIG. 6, a flow diagram is provided that illustrates an example method 600 for providing personalized query suggestions, in accordance with some implementations of the present disclosure. The method 600 can be performed, for instance, by the item listing platform 110 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, seed items are initially identified within a module carousel comprising item cards on a homepage of a user. In one example, the module carousel comprises item cards corresponding to recently viewed items. In another example, the module carousel comprises item cards corresponding to a watched items (i.e., a watchlist) of the user. In another example, the module carousel comprises item cards corresponding to frequently searched items (or recently searched items) of the user. In another example, the module carousel comprises item cards corresponding to recommended items for the user.

At block 604, embeddings for at least a portion of the seed items are retrieved. The embeddings are retrieved using any of the algorithms described herein. For example, the embeddings may be retrieved using a focus selection algorithm (e.g., a rule-based algorithm, a propensity model, or a neural network model) or a diverse selection algorithm.

In some aspects, a strategy for retrieving the embeddings is determined based on a content of the seed items. In one aspect, the strategy may be to broaden an intent of the user. For example, for modules containing specific items, the strategy may be to provide suggested queries that expand the specific items to a set of similar items. In another aspect, the strategy may be to narrow an intent of the user. For example, for modules featuring a narrow list of items, the strategy may be to provide suggested queries that prioritize common themes related to the narrow list of items. In another aspect, the strategy may be to diversify an intent of the user. For example, for modules containing diverse items (e.g., a watchlist), the strategy may be to provide suggested queries that encompass a wide range of topics to maximize coverage.

Based on the embeddings, related item embeddings corresponding to related items that were purchased by other users are identified, at block 706. In some aspects, the embeddings are utilized to retrieve related item embeddings from an interactions database. The related item embeddings correspond to related items purchased or interacted with by other users. At block 608 a list of queries is retrieved for each of the related items that were purchased by the other users. In some aspects, the list of queries is retrieved from a queries database.

At block 610, a ranking for each query of the list of queries is generated. A voting algorithm or cluster labeling algorithm, as described herein, may be utilized to rank each query. Other ranking methods may be employed to rank each query and are contemplated and within the scope of this disclosure. In some aspects, a diversification algorithm is employed to eliminate similar queries of the list of queries. Based on the ranking, queries of the list of queries are presented, at block 612, in place of at least one of the item cards within the module carousel.

Embodiments of the present invention have been described with reference to several inventive features (e.g., operations, systems, engines, and components) associated with a store management system. Inventive features described include: operations, interfaces, data structures, and arrangements of computing resources associated with providing the functionality described herein relative with reference to a store management system.

Embodiments of the present invention relate to the field of computing, and more particularly to store management systems. The following described exemplary embodiments provide a system, method, and program product to, among other things, providing personalized query suggestions using a QUICR engine of an item listing platform. Therefore, the present embodiments have the capacity to improve the technical field of store management system technology by providing more efficient user interfaces (for buyer users). For example, interfaces described for this technical solution provide a specific improvement over prior systems, resulting in an improved user interface for a store management system. In particular, the particular manner of providing personalized query suggestions do not use conventional user interface methods. The technical solution addresses conventional item listing platforms' lack of integration with a QUICR engine that improves store management system technology by enabling a user to have additional opportunities to broaden, narrow, or diversify search intents without requiring any additional real estate within the homepage of the user.

Functionality of the embodiments of the present invention have further been described, by way of an implementation and anecdotal examples—to demonstrate that the operations for providing personalized query suggestions using a QUICR engine in a store management system as a solution to a specific problem in store management platform technology to improve computing operations in store management systems.

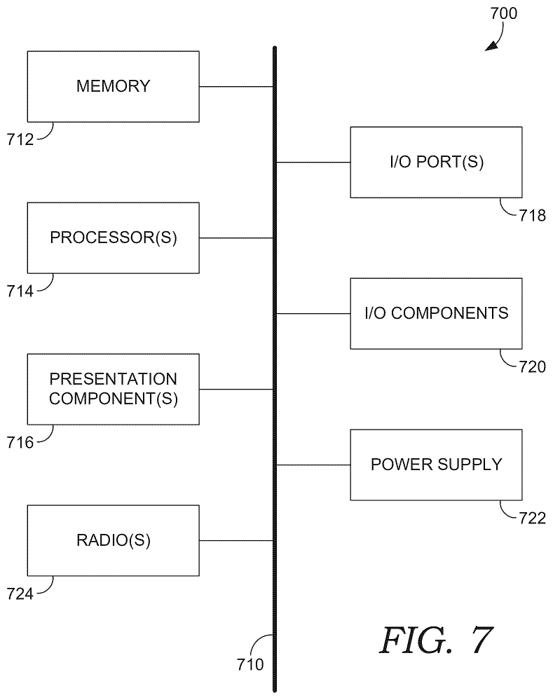

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method of generating personalized query suggestions, the method comprising:
identifying seed items within a module carousel comprising item cards on a homepage;
retrieving embeddings for at least a portion of the seed items;
based on the embeddings, identifying related item embeddings corresponding to related items that were purchased by other users;
retrieving a list of queries for each of the related items that were purchased by the other users;
generating a ranking for each query of the list of queries; and
based on the ranking, presenting queries of the list of queries in place of at least one of the item cards within the module carousel.

2. The method of claim 1, further comprising employing a diversification algorithm to eliminate similar queries of the list of queries.

3. The method of claim 1, wherein the module carousel comprises one or more of: recently viewed items, watched items, recommended items, or items corresponding to previous searches.

4. The method of claim 1, further comprising determining, based on a content of the seed items, a strategy for retrieving the embeddings.

5. The method of claim 4, wherein the strategy is to broaden an intent.

6. The method of claim 4, wherein the strategy is to narrow an intent.

7. The method of claim 4, wherein the strategy is to diversify an intent.

8. One or more computer-storage media having computer-executable instructions embodied thereon that, when executed by a computing system having a processor and memory, cause the processor to perform operations, the operations comprising:
identifying seed items within a module carousel comprising item cards on a homepage;
retrieving embeddings for at least a portion of the seed items;
based on the embeddings, identifying related item embeddings corresponding to related items that were purchased by other users;
retrieving a list of queries for each of the related items that were purchased by the other users;
generating a ranking for each query of the list of queries; and
based on the ranking, presenting queries of the list of queries in place of at least one of the item cards within the module carousel.

9. The media of claim 8, further comprising employing a diversification algorithm to eliminate similar queries of the list of queries.

10. The media of claim 8, wherein the module carousel comprises one or more of: recently viewed items, watched items, recommended items, or items corresponding to previous searches.

11. The media of claim 8, further comprising determining, based on a content of the seed items, a strategy for retrieving the embeddings.

12. The media of claim 11, wherein the strategy is to broaden an intent.

13. The media of claim 11, wherein the strategy is to narrow an intent.

14. The media of claim 11, wherein the strategy is to diversify an intent.

15. A computerized system comprising:
one or more computer processors; and
computer memory storing computer-useable instructions that, when used by the one or more computer processors, cause the one or more computer processors to perform operations, the operations comprising:
identifying seed items within a module carousel comprising item cards on a homepage;
based on embeddings for at least a portion of the seed items, identifying related item embeddings corresponding to related items that were purchased by other users;
retrieving a list of queries for each of the related items that were purchased by the other users;
generating a ranking for each query of the list of queries; and
based on the ranking, presenting queries of the list of queries in place of at least one of the item cards within the module carousel.

16. The computerized system of claim 15, further comprising retrieving the embeddings for at least a portion of the seed items.

17. The computerized system of claim 15, further comprising employing a diversification algorithm to eliminate similar queries of the list of queries.

18. The computerized system of claim 15, wherein the module carousel comprises one or more of: recently viewed items, watched items, recommended items, or items corresponding to previous searches.

19. The computerized system of claim 15, further comprising determining, based on a content of the seed items, a strategy for retrieving the embeddings.

20. The computerized system of claim 15, wherein the strategy is to broaden an intent of the user, narrow an intent of the user, or diversify an intent.
